(19) United States
(12) Patent Application Publication
(10) Pub. No.: US 2008/0227019 A1
(43) Pub. Date: Sep. 18, 2008

(54) Method and apparatus for preparing image-printed medium

(75) Inventors: Yukiko Iwasaki, Kanagawa (JP); Reki Nakamura, Kanagawa (JP); Kazuhisa Sudo, Kanagawa (JP); Megumi Ohtoshi, Kanagawa (JP); Mikio Ishibashi, Kanagawa (JP); Nobuyuki Koinuma, Kanagawa (JP); Takashi Sakamaki, Kanagawa (JP); Kazuhiko Yuki, Kanagawa (JP); Ryuji Yoshida, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/076,047

(22) Filed: Mar. 13, 2008

(30) Foreign Application Priority Data
Mar. 16, 2007 (JP) 2007-069281

(51) Int. Cl. G03G 13/14; G03G 15/20

(52) U.S. Cl. 430/125.32; 399/320

(57) ABSTRACT

A heating unit heats an image-printed medium including a transparent recording medium and a non-transparent recording medium with an image sandwiched between the transparent recording medium and the non-transparent recording medium.

### CROSS-REFERENCE TO RELATED APPLICATIONS

The present application claims priority to and incorporates by reference the entire contents of Japanese priority document 2007-069281 filed in Japan on Mar. 16, 2007.

### BACKGROUND OF THE INVENTION

1. Field of the Invention

The present invention relates to a method and an apparatus for preparing an image-printed medium, and more particularly, to a technology for forming an image on a recording medium with a gloss finish like a glossy photograph.

2. Description of the Related Art

In a typical image forming apparatus, an electrostatic latent image formed on an image carrier is developed into a toner image by a developing device, and the toner image is then transferred onto a recording medium such as a sheet. A copier, a printer, a facsimile machine, and a printing press are examples of the image forming apparatus.

A color image forming apparatus includes a plurality of image carriers. In other words, in a color image forming apparatus, toner images formed on each of the image carriers are transferred onto a recording medium in a superimposed manner to form a full-color image.

In some cases, there is a demand for giving a gloss finish like a glossy photograph to an image-printed medium.

However, the gloss finish often causes a diffuse reflection of a light illuminating the printed image. There has been a requirement to reduce such a diffuse reflection. According to a technology disclosed in Japanese Patent Application Laid-open No. 2002-341623, before a full-color toner image is fixed on a recording medium, the full-color toner image is uniformly coated with a specific toner layer for a gloss finish, and thereby improving a smoothness of a surface of the full-color toner image. According to technologies disclosed in Japanese Patent Application Laid-open No. 2004-191678 and Japanese Patent Application Laid-open No. 2003-270991, after a full-color toner image is fixed on a recording medium by the application of heat and pressure, heat and pressure are again applied to the recording medium to even a surface of the full-color toner image, and thereby obtaining a smoothness of a surface of the full-color toner image. According to a technology disclosed in Japanese Patent Application Laid-open No. H10-86562, a transparent sheet with an adhesion layer is adhered to a supporting body on which a full-color toner image is formed by the application of heat. According to a technology disclosed in Japanese Patent Application Laid-open No. H3-50586, a mirror image of a full-color toner image is formed on a transparent film, and the transparent film is adhered to a white sheet or a transparent film as a mounting.

However, in the technology disclosed in Japanese Patent Application Laid-open No. 2002-341623, a load on a fixing unit may increase because it is necessary to prepare a specific toner. Moreover, a heat load is not uniformly applied to a surface of the recording medium because a layer thickness of an image area is different from that of a non-image area.

Furthermore, in the technologies disclosed in Japanese Patent Application Laid-open No. 2004-191678 and Japanese Patent Application Laid-open No. 2003-270991, the fixing process is repeated a plurality of times, so that a configuration of the fixing unit becomes complicated and a power consumption of the fixing unit increases. Consequently, a production cost also increases.

Moreover, in the technologies disclosed in Japanese Patent Application Laid-open No. H10-86562 and Japanese Patent Application Laid-open No. H3-50586, the smoothness of the surface of the full-color toner image can be obtained by the use of a member other than the full-color toner image. However, if the adhering process is manually performed, not only it may easily cause a misalignment of the transparent sheet or the transparent film, but also air bubbles are trapped in an adhered surface. As a result, diffuse reflection occurs due to the air bubbles although a surface of the transparent film itself is smooth, and thus a decrease of the glossiness is caused.

### SUMMARY OF THE INVENTION

It is an object of the present invention to at least partially solve the problems in the conventional technology.

According to an aspect of the present invention, there is provided a method of preparing an image-printed medium includes heating an image-printed medium including a transparent recording medium and a non-transparent recording medium with an image sandwiched between the transparent recording medium and the non-transparent recording medium.

According to another aspect of the present invention, there is provided an image-printed-medium preparing apparatus including a heating unit that heats an image-printed medium including a transparent recording medium and a non-transparent recording medium with an image sandwiched between the transparent recording medium and the non-transparent recording medium.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming apparatus including a gloss finishing device according to an embodiment of the present invention;

FIG. 2 is an enlarged view of a photosensitive unit and a developing unit included in an image forming unit shown in FIG. 1;

FIG. 3 is an enlarged view of the gloss finishing device shown in FIG. 1;

FIG. 4A is a schematic diagram for explaining how a toner image sandwiched between a transparent recording medium and a non-transparent recording medium is seen through the transparent recording medium;

FIG. 4B is a schematic diagram for explaining a surface of a toner image viewed from an opposite direction to that is shown in FIG. 4A;

FIGS. 5A and 5B are schematic diagrams for explaining diffuse reflection caused by air bubbles; and

FIGS. 6A to 6C are schematic diagrams for explaining how air bubbles are dispersed with being broken down into minute air bubbles by the application of heat.

### DETAILED DESCRIPTION OF THE PREFERRED EMBODIMENTS

Exemplary embodiments according to the present invention are explained in detail below with reference to the accompanying drawings.

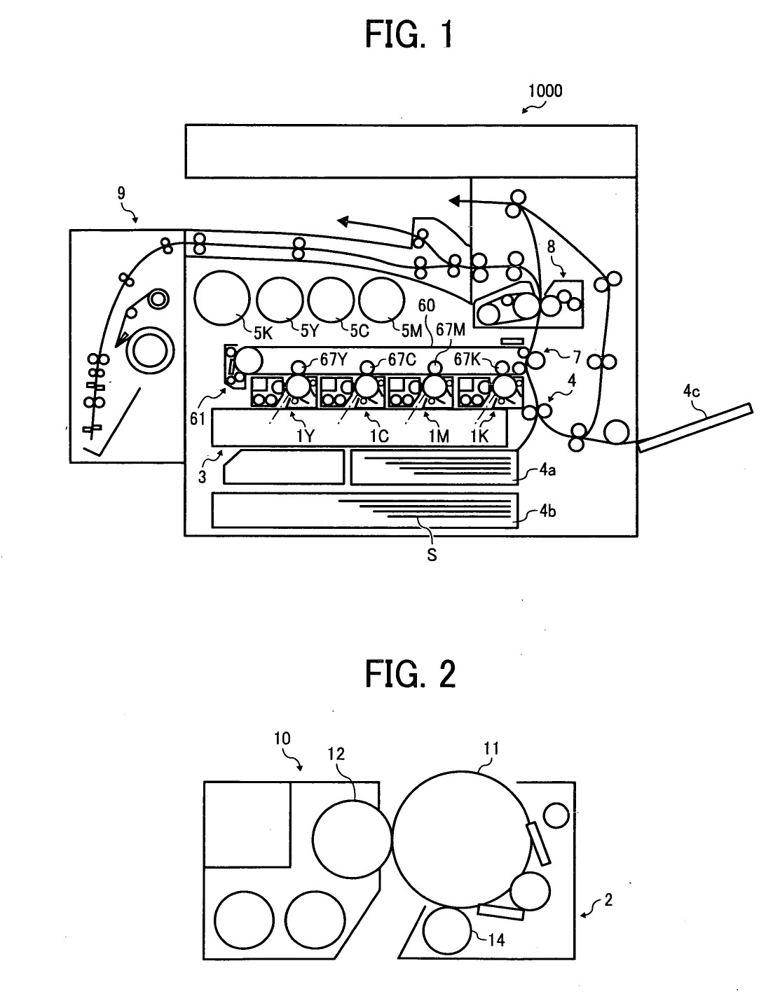

FIG. 1 is a schematic diagram of an image forming apparatus 1000 including a gloss finishing device 9 as an image-printed-medium preparing apparatus according to an embodiment of the present invention.

The image forming apparatus 1000 includes four image forming units 1 (1Y, 1C, 1M, and 1K), an optical writing unit 3, a pair of registration rollers 4, a primary transfer unit (not shown), a secondary transfer unit 7, a fixing unit 8, the gloss finishing device 9, sheet feeding cassettes 4a and 4b, a manual sheet feeding tray 4c, toner replenishing containers 5Y, 5C, SM, and 5K, a waste toner bottle (not shown), and a power supply unit (not shown). The image forming units 1Y, 1C, 1M, and 1K form yellow (Y), cyan (C), magenta (M), and black (K) color images, respectively. As shown in FIG. 1, the image forming units 1Y, 1C, 1M, and 1K are aligned in this order from the left to the right. The order of the image forming units 1Y, 1C, 1M, and 1K is not limited to that is shown in FIG. 1.

Each of the image forming units 1Y, 1C, 1M, and 1K includes a photosensitive drum 11 (11Y, 11C, 11M, or 11K) as an image carrier, a charging unit, a developing unit 10 (10Y, 10C, 10M, or 10K), and a cleaning unit. The image forming units 1Y, 1C, 1M, and 1K are set up to be arranged in such a way that rotating shafts of the photosensitive drums 11Y, 11C, 11M, and 11K are arranged to be parallel to one another at predetermined intervals in a sheet conveying direction.

The optical writing unit 3 is arranged below the image forming units 1Y, 1C, 1M, and 1K, and includes a light source, a polygon mirror, an f−θ lens, and a reflection mirror. The optical writing unit 3 emits a laser light to each surface of the photosensitive drums 11Y, 11C, 11M, and 11K based on image data.

The primary transfer unit 6 includes a transfer belt 60, a cleaning unit 61, and primary transfer rollers 67 (67Y, 67C, 67M, and 67K), and is arranged above the optical writing unit 3. The primary transfer unit 6 primarily transfers toner images formed on the photosensitive drums 11Y, 11C, 11M, and 11K onto the transfer belt 60 in a superimposed manner. The transfer belt 60 is supported by a plurality of rollers, and moves with having contact with the photosensitive drums 11Y, 11C, 11M, and 11K on one of its supported surfaces. The transfer belt 60 is arranged so that an outer circumferential surface of the transfer belt 60 has contact with the cleaning unit 61.

The cleaning unit 61 includes a brush roller and a cleaning blade, and removes residual toners from the transfer belt 60.

The secondary transfer unit 7 is arranged on the right side of the primary transfer unit 6, and secondary-transfers the toner images on the transfer belt 60 onto a transfer sheet. The fixing unit 8 is arranged above the secondary transfer unit 7, and fixes the toner images on the transfer sheet by a belt fixing method.

The sheet feeding cassettes 4a and 4b are arranged at the bottom of the image forming apparatus 1000, and respectively contain therein transfer sheets S. The manual sheet feeding tray 4c is arranged on a side surface of the image forming apparatus 1000. A transfer sheet S is automatically fed from the sheet feeding cassette 4a or 4b, or manually fed from the manual sheet feeding tray 4c. The toner replenishing containers 5Y, 5C, 5M, and 5K, the waste toner bottle (not shown), and the power supply unit (not shown) are arranged above the transfer belt 60.

The developing units 10Y, 10C, 10M, and 10K have the same configuration except for a color of a toner contained therein. The developing units 10Y, 10C, 10M, and 10K employ a two-component development method, and respectively contain therein a developer composed of a toner and a magnetic carrier.

Each of the developing units 10Y, 10C, 10M, and 10K includes a developing roller, a screw, and a toner concentration sensor. The developing roller is arranged to be opposed to the photosensitive drum 11. The screw is used to convey and stir the developer.

The developing roller includes a rotatable sleeve and a magnet. The developing roller is covered with the sleeve. The magnet is fixed on an inner surface of the developing roller. Based on an output from the toner concentration sensor, the developer is replenished with a toner.

FIG. 2 is an enlarged view of a photosensitive unit 2 and the developing unit 10. The photosensitive unit 2 includes the photosensitive drum 11 and a charging roller 14. The developing unit 10 includes a developing roller 12. A predetermined voltage from a power source (not shown) is applied to the charging roller 14, and thereby charging a surface of the photosensitive drum 11 having contact with the charging roller 14. When the surface of the photosensitive drum 11 is charged to a predetermined potential, the surface of the photosensitive drum 11 is exposed to a laser light based on image data by the optical writing unit 3. As a result, an electrostatic latent image is formed on the surface of the photosensitive drum 11. When the electrostatic latent image formed on the surface of the photosensitive drum 11 comes to the developing unit 10 in accordance with a rotation of the photosensitive drum 11, a toner is supplied to the electrostatic latent image by the developing roller 12 having contact with the photosensitive drum 11. By the supply of the toner from the developing roller 12, the electrostatic latent image is developed into a toner image.

Such a process of developing an electrostatic latent image into a toner image is performed in the each of the image forming units 1Y, 1C, 1M, and 1K at a predetermined timing. Namely, Y, C, M, and K toner images are respectively formed on surfaces of the photosensitive drums 11Y, 11C, 11M, and 11K at the predetermined timing.

When a transfer sheet S fed from any of the sheet feeding cassettes 4a or 4b and the manual sheet feeding tray 4c comes to the registration rollers 4, the feed of the transfer sheet S is temporarily stopped. The Y, C, M, and K toner images formed on the photosensitive drums 11Y, 11C, 11M, and 11K are sequentially transferred onto the transfer belt 60 in keeping with the timing when each of the Y, C, M, and K toner image is formed. A voltage from a power source (not shown) is applied to the photosensitive drums 11Y, 11C, 11M, and 11K via the primary transfer rollers 67Y, 67C, 67M, and 67K having contact with the photosensitive drums 11Y, 11C, 11M, and 11K across the transfer belt 60, respectively. Incidentally, a polarity of the voltage from the power source is opposite to that of the toners of the Y, C, M, and K toner images. As a result, the Y, C, M, and K toner images formed on the photosensitive drums 11Y, 11C, 11M, and 11K are sequentially transferred onto the transfer belt 60 in a superimposed manner.

When the transfer belt 60 passes through the photosensitive drum 11K and the primary transfer roller 67K those located in the last stage of each of the units respectively, all the Y, C, M, and K toner images are transferred onto the transfer belt 60 in a superimposed manner. The superimposed toner images on the transfer belt 60 are secondarily transferred onto the transfer sheet S fed out from the registration rollers 4 by the secondary transfer unit 7. After that, the transfer sheet S is conveyed to the fixing unit 8, and the fixing unit 8 fixes the superimposed toner images on the transfer sheet S by the application of heat and pressure.

The gloss finishing device 9 applies a gloss finish to the transfer sheet S on which the superimposed toner images are fixed. In the present embodiment, when a gloss finish is to be applied, toner images formed in the same manner as the normal image forming process are fixed on a transparent recording medium. The transparent recording medium on which the toner images are fixed is conveyed to the gloss finishing device 9. The gloss finishing device 9 laminates a non-transparent recording medium with an adhesive layer on the transparent recording medium in such a manner that the toner images are sandwiched between the transparent recording medium and the non-transparent recording medium. This combination of the transparent recording medium, the non-transparent recording medium and the toner image sandwiched therebetween will be called as an image-printed medium. After that, the gloss finishing device 9 applies heat to the image-printed medium so that the non-transparent recording medium adheres to the transparent recording medium. The transparent recording medium includes a transfer sheet.

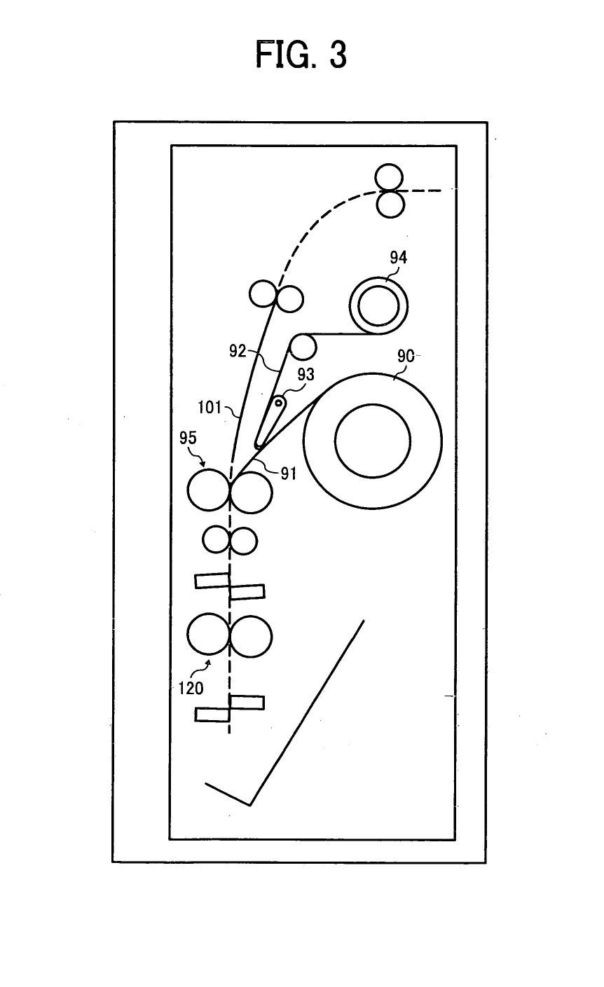

A configuration of the gloss finishing device 9 is explained in detail below with reference to FIG. 3.

The gloss finishing device 9 includes a non-transparent recording-medium roll 90, a peeling member 93, a release-paper reel 94, a pair of pressure rollers 95, and a heating unit 120. An adhesive layer is formed on a surface of the non-transparent recording-medium roll 90, and covered with a release paper 92. The peeling member 93 peels off the release paper 92 from the non-transparent recording-medium roll 90 by taking advantage of a curvature of the peeling member 93. The peeled release paper 92 is wound on the release-paper reel 94. When a transparent recording medium 101 on which toner images are fixed is conveyed from the fixing unit 8 to the gloss finishing device 9, the transparent recording medium 101 passes through the pressure rollers 95 together with a non-transparent recording medium 91 that is a portion of the non-transparent recording-medium roll 90 from which the release paper 92 is peeled off so that the transparent recording medium 101 and the non-transparent recording medium 91 are faced with each other in such a way that the toner images on the transparent recording medium 101 are sandwiched between the transparent recording medium 101 and the non-transparent recording medium 91 thereby forming a image-printed medium. When the image-printed medium passes through the pressure rollers 95, the transparent recording medium 101 and the non-transparent recording medium 91 are pressed against each other, so that the non-transparent recording medium 91 adheres to the transparent recording medium 101. The heating unit 120 applies heat to the image-printed medium so that air bubbles trapped in the adhesive layer can be eliminated or dispersed with being broken down into minute air bubbles.

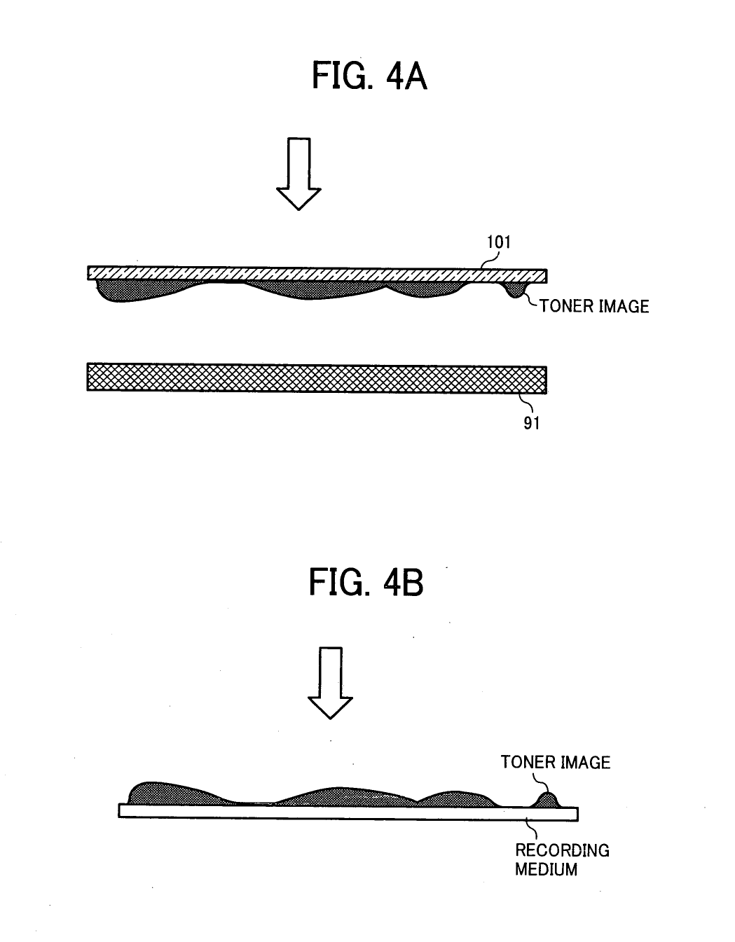

FIG. 4A is a schematic diagram for explaining how toner images sandwiched between the transparent recording medium 101 and the non-transparent recording medium 91 are seen through the transparent recording medium 101. As shown in FIG. 4A, an outer surface of the transparent recording medium 101 on the side opposite to that is adhered to the non-transparent recording medium 91 is made flat and smooth, so that it can be said that a smoothness of a surface of the toner images on the side of the transparent recording medium 101 is ensured. Therefore, no diffuse reflection occurs when the toner images are viewed from a direction of an arrow shown in FIG. 4A. Thus, it is possible to improve a glossiness of a full-color image formed from the toner images.

FIG. 4B is a schematic diagram for explaining a case in which a toner image is viewed from a direction opposite to the arrow shown in FIG. 4A. In this case, a surface of the toner image viewed from a direction of an arrow shown in FIG. 4B is uneven, so that the glossiness cannot be obtained properly.

Subsequently, a process of eliminating the air bubbles trapped in the adhesive layer is explained in detail below.

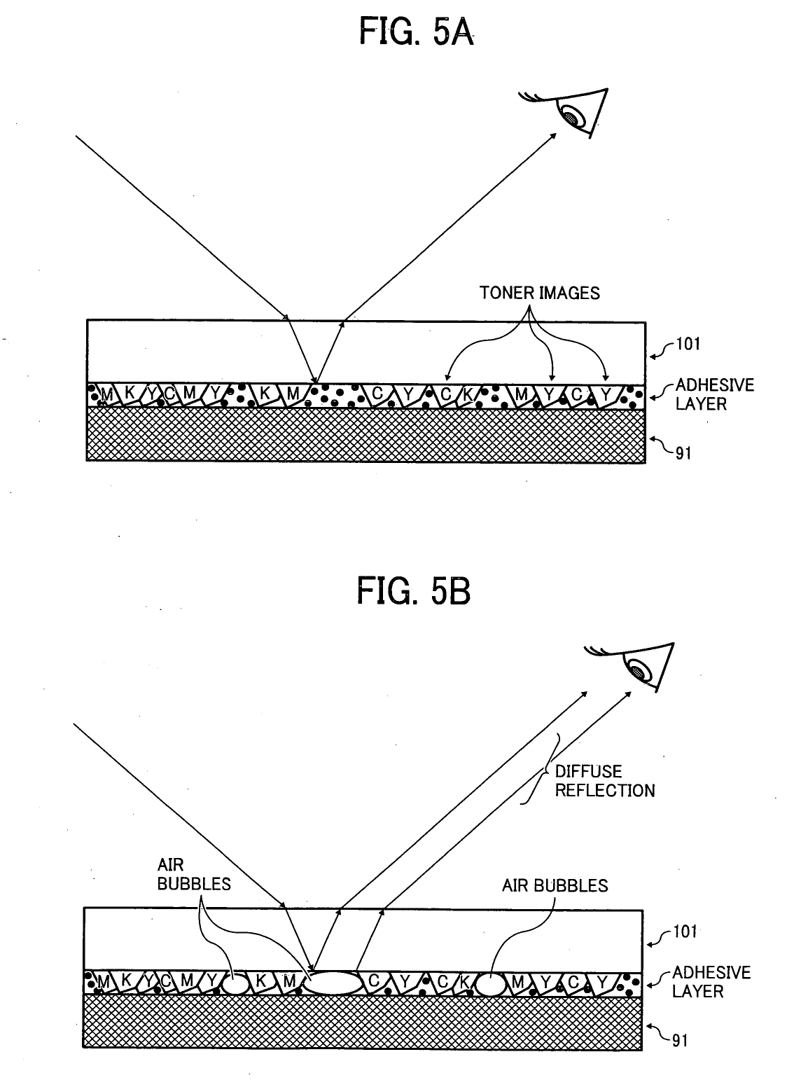

FIG. 5A is a schematic diagram for explaining a case in which no air bubble is trapped in the adhesive layer. FIG. 5B is a schematic diagram for explaining a case in which air bubbles are trapped in the adhesive layer. In the case shown in FIG. 5B, a diffuse reflection occurs due to the air bubbles. Incidentally, “C”, “M”, “Y”, and “K” shown in FIGS. 5A and 5B indicate C, M, Y, and K toner images, respectively.

As described above, to obtain the proper glossiness, the outer surface of the transparent recording medium 101 and the surface of the toner images need to be made flat and smooth. However, when the non-transparent recording medium 91 adheres to the transparent recording medium 101, ambient air is trapped between the non-transparent recording medium 91 and the transparent recording medium 101. As a result, as shown in FIG. 5B, the air bubbles are trapped in the adhesive layer. The existence of the air bubbles is equivalent to a case in which the surface of the toner images is uneven, so that the glossiness cannot be obtained properly.

In the present embodiment, after the non-transparent recording medium 91 adheres to the transparent recording medium 101 on which the toner images are fixed, the non-transparent recording medium 91 and the transparent recording medium 101 are heated by the heating unit 120 so that the air bubbles trapped in the adhesive layer can be dispersed with being broken down into minute air bubbles.

At this time, the heat applied to the non-transparent recording medium 91 and the transparent recording medium 101 needs to be controlled so that the toner images and the adhesive layer are not fused but softened. The air bubbles are dispersed with being broken down into minute air bubbles by the action of an increase in pressure caused by the heat.

An amount of the heat applied to the non-transparent recording medium 91 and the transparent recording medium 101 is lower than that with which a fusion of the toner images fixed on the transparent recording medium 101 occurs, otherwise an image distortion will occur due to the fusion of the toner images. In addition, the amount of the heat is set up to an amount enabling to decrease viscosities of the toner images and the adhesive layer so that the air bubbles can be easily moved.

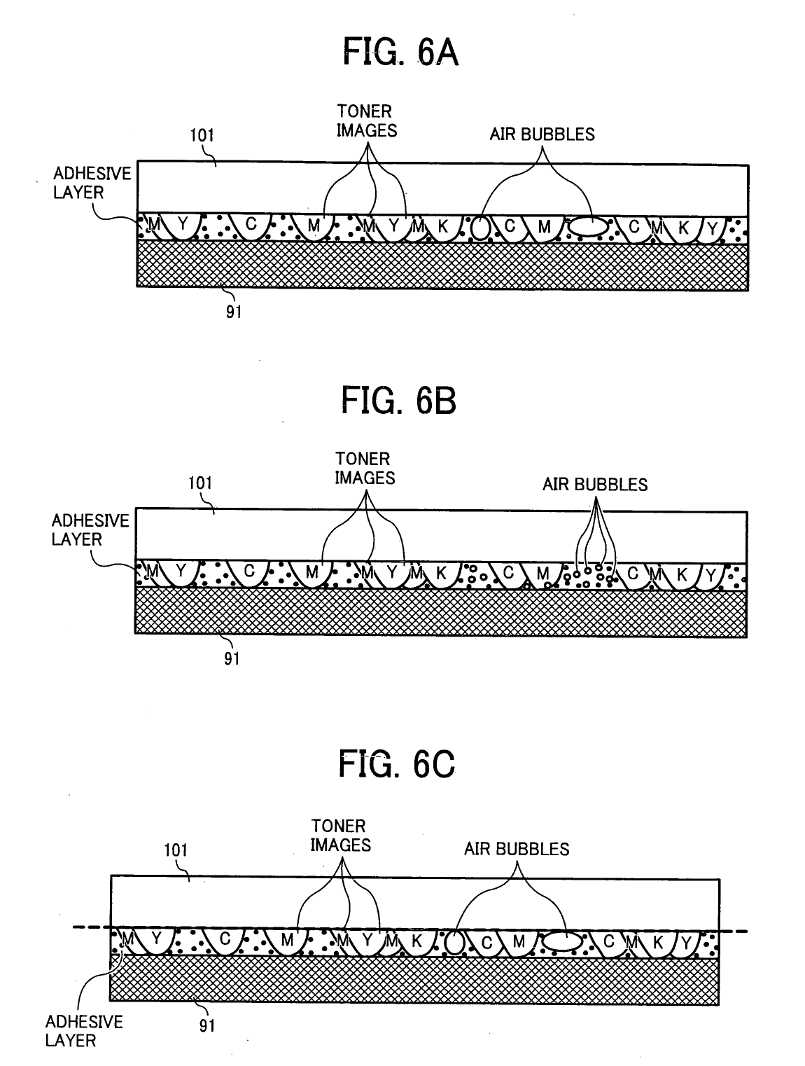

A heating process performed by the heating unit 120 is explained below with reference to FIGS. 6A to 6C. FIG. 6A is a schematic diagram for explaining a state of the air bubbles trapped in the adhesive layer before the heating unit 120 performs the heating process. FIG. 6B is a schematic diagram for explaining how the air bubbles are dispersed with being broken down into minute air bubbles by the heating process.

As shown in FIG. 6A, air bubbles are trapped in the adhesive layer before the heating unit 120 performs the heating process. When the non-transparent recording medium 91 and the transparent recording medium 101 are heated, as shown in FIG. 6B, the air bubbles are dispersed with being broken down into minute air bubbles by the action of an increase in pressure caused by the heat, and some of the minute air bubbles can be eliminated from the adhesive layer. Therefore, a degree of the diffuse reflection can be reduced, and thus it is possible to prevent the glossiness from being degraded.

Particularly, when the diffuse reflection occurs in a boundary between the toner images and the transparent recording medium 101 as indicated by a dashed line shown in FIG. 6C, the glossiness are highly influenced by the diffuse reflection. Therefore, in the present embodiment, an amount of the heat applied to the transparent recording medium 101 is configured to be smaller than that is applied to the non-transparent recording medium 91, and thereby promoting the softening action on toners of the toner images located on the side of the non-transparent recording medium 91 and the movement of the air bubbles towards the non-transparent recording medium 91. Alternatively, the amount of the heat applied to the transparent recording medium 101 can be set up to a vanishingly low level.

When the amount of the heat applied to the non-transparent recording medium 91 is set up to be lower than that with which a fusion of the toner images will occur to prevent the toner images on the side of the transparent recording medium 101 from being fused again. For example, it is possible to heat only the non-transparent recording medium 91, i.e., to not heat the transparent recording medium 101.

In this manner, the amount of the heat is graded between the non-transparent recording medium 91 and the transparent recording medium 101, so that the movement of the air bubbles to the boundary shown in FIG. 6C is prevented. Consequently, the occurrence of the diffuse reflection of the light illuminating the toner images can be prevented, so that the image can be formed with the high glossiness.

A combination of the image forming apparatus 1000 including the gloss finishing device 9 is explained above. However, the gloss finishing device 9 can be provided as a separate unit. In this case, a transparent recording medium with an image is fed to the gloss finishing device 9.

Furthermore, the image forming apparatus is not limited to the electrophotographic image forming apparatus. In other words, the image forming apparatus can be an ink-jet image forming apparatus.

According to an aspect of the present invention, an image-printed medium in which an image is sandwiched between a transparent recording medium and a non-transparent recording medium are heated to obtain a glossy-finish image-printed medium. Therefore, it is possible to ensure a smoothness of an outer surface of the transparent recording medium on a side of which the transparent recording medium is not adhered to the non-transparent recording medium, and thereby obtaining the glossiness of the image. In addition, air bubbles trapped in an adhered surface between the transparent recording medium and the non-transparent recording medium can be dispersed with being broken down into minute air bubbles by the application of heat. Therefore, it is possible to prevent occurrence of diffuse reflection caused by the air bubbles, and thereby preventing a decrease of the glossiness of the image. Particularly, by setting a heat condition for controlling the air bubbles not to be concentrated on a side of the transparent recording medium, it is possible to prevent the decrease of the glossiness.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of preparing an image-printed medium comprising heating an image-printed medium including a transparent recording medium and a non-transparent recording medium with an image sandwiched between the transparent recording medium and the non-transparent recording medium.

2. The method according to claim 1, wherein the image is carried on the transparent recording medium, and the method further comprising adhering the non-transparent recording medium to the transparent recording medium that carries the image via an adhesive layer thereby obtaining the image-printed medium.

3. The method according to claim 2, wherein the image has been fixed on the transparent recording medium.

4. The method according to claim 1, wherein the heating includes heating the image-printed medium at an amount of heat lower than that with which a toner contained in the image fuses.

5. The method according to claim 3, wherein the heating includes heating the non-transparent recording medium at an amount of heat higher than that is applied to the transparent recording medium.

6. The method according to claim 2, wherein the heating includes heating the transparent recording medium at an amount of heat higher than that with which an adhesive material of the adhesive layer fuses.

7. An image-printed-medium preparing apparatus comprising a heating unit that heats an image-printed medium including a transparent recording medium and a non-transparent recording medium with an image sandwiched between the transparent recording medium and the non-transparent recording medium.

8. The image-printed-medium preparing apparatus according to claim 7, wherein the image is carried on the transparent recording medium, and the image-printed-medium preparing apparatus further comprising an adhering unit that adheres the non-transparent recording medium to the transparent recording medium that carries the image via an adhesive layer thereby obtaining the image-printed medium.

9. The image-printed-medium preparing apparatus according to claim 8, wherein the image has been fixed on the transparent recording medium.

10. The image-printed-medium preparing apparatus according to claim 7, wherein the heating unit heats the image-printed medium at an amount of heat lower than that with which a toner contained in the image fuses.

11. The image-printed-medium preparing apparatus according to claim 9, wherein the heating unit heats the non-transparent recording medium at an amount of heat higher than that is applied to the transparent recording medium.

12. The image-printed-medium preparing apparatus according to claim 8, wherein the heating unit heats the transparent recording medium at an amount of heat higher than that with which an adhesive material of the adhesive layer fuses.
